(19) United States
(12) Patent Application Publication
(10) Pub. No.: US 2016/0214283 A1
(43) Pub. Date: Jul. 28, 2016

(54) COMPOSITE TOOL AND METHOD FOR FORMING COMPOSITE COMPONENTS

(71) Applicant: GENERAL ELECTRIC COMPANY, Schenectady, NY (US)

(72) Inventors: David Edward SCHICK, Greenville, SC (US); Jason Robert PAROLINI, Greer, SC (US); Matthew Troy HAFNER, Honea Path, SC (US); Steven BARNELL, Pelzer, SC (US)

(21) Appl. No.: 14/604,910

(22) Filed: Jan. 26, 2015

(51) Int. Cl. B29C 33/56; B29C 70/44; B29C 33/38; B29C 70/34; F01D 5/28; F01D 5/22

(52) U.S. Cl. CPC B29C 33/56; F01D 5/282; F01D 5/225; B29C 33/3842; B29C 70/34; B29C 70/44; B33Y 10/00

(57) ABSTRACT

Provided are a composite tool and a method for forming composite components. The composite tool includes a three dimensionally printed polymer body, the body having a geometry corresponding to at least one surface of a gas turbine component; and a coating overlaying the body, the coating providing the printed polymer body a greater resistance to heat exposure than an uncoated printed polymer body. The method for forming a composite component includes providing a composite tool; laying-up a plurality of composite plies on a surface of the composite tool; densifying the composite plies to form a composite component; and removing the composite tool from the composite component. The composite component includes a surface geometry corresponding to at least a portion of the composite tool. Also provided is a method of forming the composite tool.

### FIELD OF THE INVENTION

The present invention relates generally to gas turbines for power generation and more specifically to methods of forming composite components for gas turbines.

### BACKGROUND OF THE INVENTION

Ceramic matrix composite (CMC) materials have been proposed as materials for certain components of gas turbine engines, such as the turbine blades, vanes, nozzles, and buckets. Various methods are known for fabricating CMC components, including Silicomp, melt infiltration (MI), chemical vapor infiltration (CVI), polymer inflation pyrolysis (PIP), and oxide/oxide processes. Though these fabrication techniques significantly differ from each other, each involves the use of hand lay-up and tooling or dies to produce a near-net-shape part through a process that includes the application of heat at various processing stages.

Forming CMC components includes a number of steps, including using pre-forms such as mandrels or molds. First, a plurality of CMC fibers are laid up on a steel or aluminum mandrel. The fibers are laid up in a pre-determined pattern to provide desired final or near-net-shape and desired mechanical properties of component. After the fibers have been laid up, a binder is removed from the fibers through a burn-out cycle, during which the mandrel provides support and strength to the component.

The shape of the mandrel upon which the CMC fibers are laid up provides the shape of the CMC component. However, the shape of the mandrels is limited to shapes that can be traditionally machined. As such, the shape of the CMC component is limited to the shapes that can be traditionally machined without further processing. In addition, due to the machining process for forming steel or aluminum mandrels, manufacturing the mandrels may take weeks or months to complete.

A component and a method that show one or more improvements in comparison to the prior art would be desirable in the art.

### SUMMARY OF THE INVENTION

In one embodiment, a composite tool includes a three dimensionally printed polymer body, the body having a geometry corresponding to at least one surface of a gas turbine component; and a coating overlaying the body, the coating providing the printed polymer body a greater resistance to heat exposure than an uncoated printed polymer body.

In another embodiment, a method of forming a composite tool includes printing a three dimensional polymer body, the body having a geometry corresponding to at least one surface of a gas turbine component; and applying a coating to the polymer body, the coating providing the printed polymer body a greater resistance to heat exposure than an uncoated printed polymer body.

In another embodiment, a method of forming a composite component includes providing a composite tool including a three dimensionally printed polymer body, and a coating overlaying the body, the coating providing the printed polymer body a greater resistance to heat exposure than an uncoated printed polymer body; laying-up a plurality of composite plies on a surface of the composite tool; densifying the composite plies to form a composite component; and removing the composite tool from the composite component. The composite component includes a surface geometry corresponding to at least a portion of the composite tool.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a perspective view of a composite tool, according to an embodiment of the disclosure.

FIG. 2 is a perspective view of a composite component formed over the composite tool of FIG. 1.

FIG. 3 is a perspective view of a composite tool, according to an embodiment of the disclosure.

FIG. 4 is a perspective view of a composite component formed over the composite tool of FIG. 3.

FIG. 5 is a section view of a coated composite tool, according to an embodiment of the disclosure.

FIG. 6 is an exploded view of a composite tool, according to an embodiment of the disclosure.

FIG. 7 is a process view of a method of forming a composite component, according to an embodiment of the disclosure.

FIG. 8 is a section view of a composite component having a composite tool removed therefrom, according to an embodiment of the disclosure.

FIG. 9 is a section view of a composite component having a portion of a composite tool removed therefrom, according to an embodiment of the disclosure.

FIG. 10 is a section view of a composite component including a composite tool therein, according to an embodiment of the disclosure.

Wherever possible, the same reference numbers will be used throughout the drawings to represent the same parts.

### DETAILED DESCRIPTION OF THE INVENTION

Provided are a composite tool and a method of forming a composite tool. Embodiments of the present disclosure, for example, in comparison to concepts failing to include one or more of the features disclosed herein, decrease manufacturing cost, decrease manufacturing time, increase efficiency, decrease mandrel weight, increase mandrel mobility, increase mandrel shape flexibility, permit formation of additional composite tool shapes, permit formation of composite tools having complex geometries, permit usage of polymer mandrels at temperatures above the glass transition temperature of the polymer, decrease deformation of polymer mandrels at temperatures above the glass transition temperature of the polymer, increase layup tooling iteration, decrease component porosity, decrease component breakage, or a combination thereof.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Systems used to generate power include, but are not limited to, gas turbines, steam turbines, and other turbine assemblies such as land based aero-derivatives used for power generation. In certain applications, the power generation systems, including the turbomachinery therein (e.g., turbines, compressors, and pumps) and other machinery may include components that are exposed to heavy wear conditions. For example, certain power generation system components, such as blades, buckets, casings, rotor wheels, shafts, shrouds, nozzles, and so forth, may operate in high heat and high revolution environments. These components are manufactured using composite materials and composite tools. The present disclosure provides methods to form composite tools and composite components.

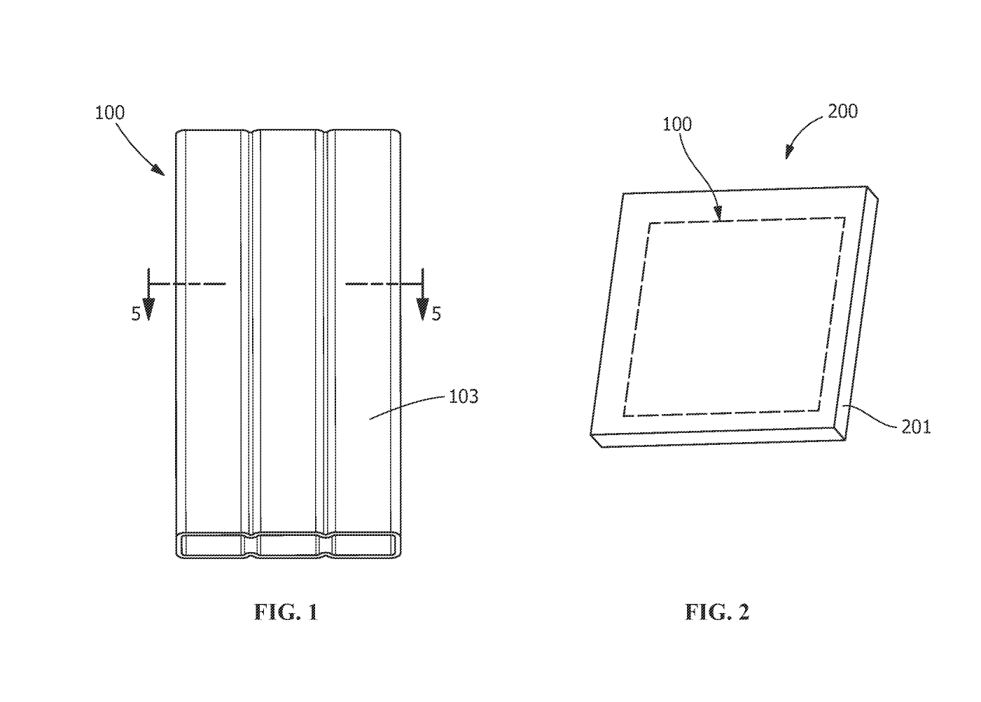

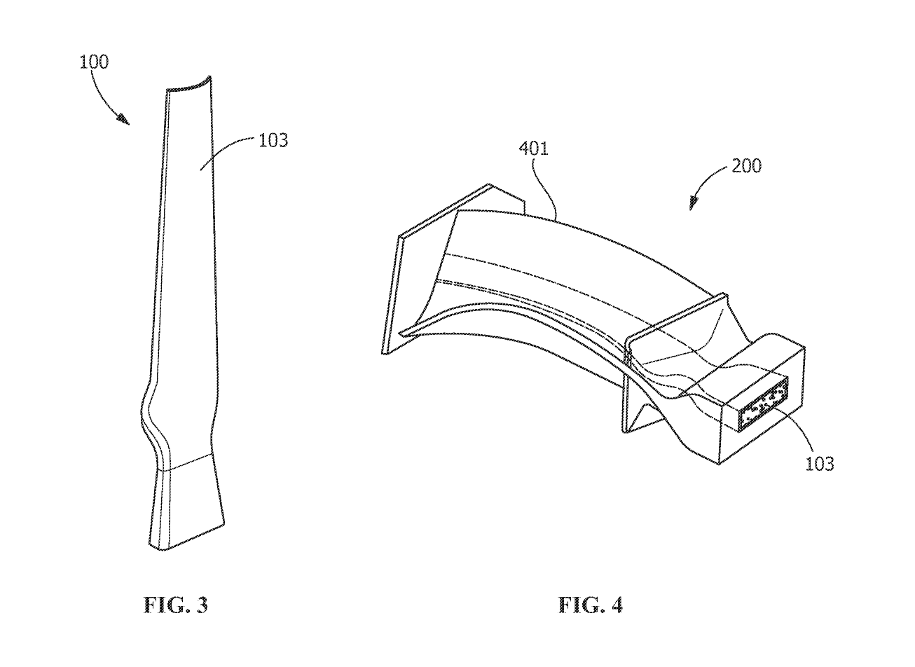

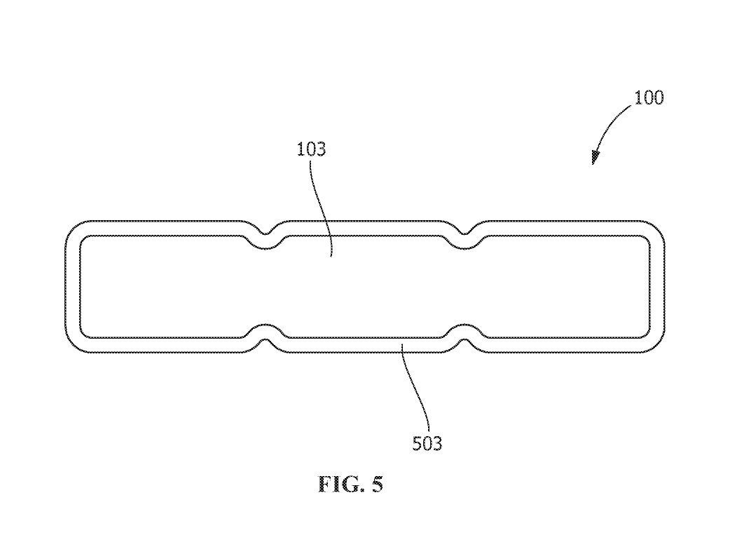

Referring to FIGS. 1-4, a composite tool 100 (FIGS. 1 and 3) includes any tool for forming a composite component 200 (FIGS. 2 and 4). In one embodiment, the composite tool 100 includes a mold, a mandrel 101, or any other article configured for forming the composite component 200 thereon. In another embodiment, the composite tool 100 includes a body 103. In a further embodiment, the body 103 includes a three dimensionally printed body. Three dimensional printing includes, but is not limited to, the processes known to those of ordinary skill in the art as Direct Metal Laser Melting (DMLM), Direct Metal Laser Sintering (DMLS), Laser Engineered Net Shaping (LENS), Selective Heat Sintering (SHS), Selective Laser Sintering (SLS), Selective Laser Melting (SLM), Electron Beam Melting (EBM), Fused Deposition Modeling (FDM), or a combination thereof.

The three dimensionally printed body includes any suitable geometry, facilitating the formation of additional shapes and designs as compared to machining. Additionally, three dimensionally printing the body 103 decreases or eliminates lead time and/or machining of the composite tool 100. Suitable geometries include, but are not limited to, geometries corresponding to at least one surface of the composite component 200, geometries corresponding to features within the composite component 200, or a combination thereof. For example, referring to FIGS. 1-2, in one embodiment, the body 103 is three dimensionally printed with a geometry corresponding to a shroud 201 (FIG. 2). Referring to FIGS. 3-4, in another embodiment, the body 103 is three dimensionally printed with a geometry corresponding to a turbine bucket 401 (FIG. 4).

The three dimensionally printed body is formed from any material capable of being three dimensionally printed. Suitable materials include, but are not limited to, polymers, water soluble materials, metals, or a combination thereof. For example, in one embodiment, the polymers include plastics, high temperature plastics, thermoplastics, thermosets, elastomers, or a combination thereof. In another embodiment, the polymers and/or the high temperature plastics are three dimensionally printed using SHS, SLS, FDM, or a combination thereof. In a further embodiment, the plastic includes a polyetherimide (PEI) such as Ultem® 9085 and/or a polyphenylsulfone (PPSF or PPSU), both of which are commercially available from Stratasys, Ltd. of Eden Prairie, Minn., a polyetheretherketone (PEEK), or a combination thereof.

“ULTEM” is a federally registered trademark of thermoplastics produced by Stratasys, Ltd., Eden Prairie, Minn.

In an alternate embodiment, the body 103 may be formed from a three dimensionally printed metal, such as steel or aluminum. The three dimensionally printed metal provides an increased service temperature as compared to the three dimensionally printed polymer, while the three dimensionally printed polymer decreases a cost of the composite tool 100, decreases a weight of the composite tool 100, facilitates movement of the composite tool 100, or a combination thereof. The term “service temperature”, as used herein, refers to a temperature at which a material may be used without substantial deformation and/or degradation of the material's geometry and/or material properties. Additionally, polymers and/or plastics may be three dimensionally printed with dissolvable supports, which facilitates the formation of geometries or shapes having increased complexity as compared to metals. For example, highly curved parts, such as turbine buckets, may be printed with plastic having supports which are easily removed after printing by dissolving or breaking away. Furthermore, plastics may be three dimensionally printed at an increased rate as compared to metals.

In one embodiment, the three dimensionally printed body includes two or more separate materials. For example, the body 103 may include a first material having a first service temperature, and a second material having a second service temperature. In another embodiment, the second material is positioned over the first material, the second material forming an outer surface having an increased or greater resistance to heat exposure. In a further embodiment, the first material is a water soluble material and the second material is a non-water soluble material. The first material and the second material may be printed together, then the water soluble first material may be leached out.

Referring to FIG. 5, in one embodiment, the composite tool 100 includes a coating 503 overlaying the body 103. The coating 503 includes any coating material that sticks to and/or surrounds the body 103, and has a service temperature greater than the service temperature of the polymer(s) used to form the body 103. For example, in one embodiment, the coating material has a service temperature greater than 367° F., which is the glass transition temperature of Ultem® 9085. Suitable coating materials include, but are not limited to, nickel, copper, aluminum, platinum, or a combination thereof.

When applied to the body 103, the coating 503 provides an increased or greater resistance to heat exposure, strength, flexural resistance, or combination thereof, as compared to an uncoated three dimensionally printed material. The increased resistance to heat exposure facilitates survival of the composite tool 100 when exposed to a temperature greater than the service and/or glass transition temperature of the three dimensionally printed polymer body. For example, in one embodiment, the coating 503 decreases or eliminates changes in a geometry, shape, and/or configuration of the body 103 at temperatures above the service and/or glass transition temperature of the material of the body 103. In another embodiment, the coating 503 provides increased rigidity to the composite tool 100. The increased rigidity maintains or substantially maintains the dimensions of the composite tool 100 at temperatures above the service and/or glass transition temperature of the body 103, such as, but not limited to, during an autoclave burnout cycle. Additionally, by decreasing or eliminating changes in the geometry, shape, and/or configuration of the body 103 and/or the composite tool 100, the coating 503 facilitates the use of materials having service and/or glass transition temperatures below a cure cycle temperature of the composite tool 100 and/or the composite component 200. The use of materials with service and/or glass transition temperatures below the cure cycle temperature of the composite tool 100 and/or the composite component 200 decreases manufacturing cost and/or increases prototype speed.

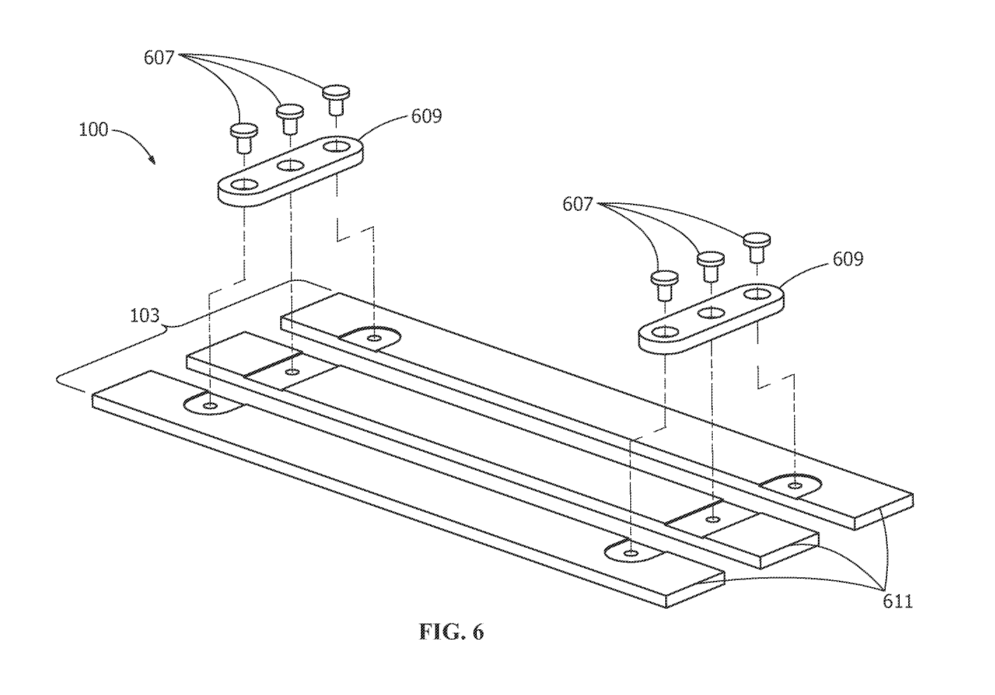

As illustrated in FIG. 6, the composite tool 100 may include one or more segments 611. Each of the segments 611 forms at least a portion of the body 103. The one or more segments 611 are attachable to each other, the attached segments 611 forming the geometry corresponding to at least one surface of the composite component 200. For example, the body 103 may be formed from a plurality of the segments 611 which are joined together and coated with the coating 503 to form the composite tool 100 having a geometry corresponding to a gas turbine component. In a further embodiment, the segments 611 may be attached with pins 607, sockets 609, and/or any other attaching feature. Alternatively, the segments 611 are printed with interlocking features that facilitate attaching the segments 611 together.

The composite component 200 is formed over the composite tool 100, and includes any component formed from composite materials, such as, but not limited to, a power generation system component, a turbomachinery component, a gas turbine component, or a combination thereof. For example, suitable gas turbine components include, but are not limited to, shrouds 201 (FIG. 2), turbine buckets 401 (FIG. 4), compressor blades, nozzles, hot gas path components, or a combination thereof. The composite materials include, but are not limited to, carbon composites, epoxy composites, polymer matrix composites (PMC), ceramic matrix composites (CMC), or a combination thereof. For example, the CMC may be an oxide based CMC including materials such as, but not limited to alumina, mullite, boron nitride, boron carbide, sialons (silicon, aluminum, oxygen, and nitrogen), intermetallics, and combinations thereof.

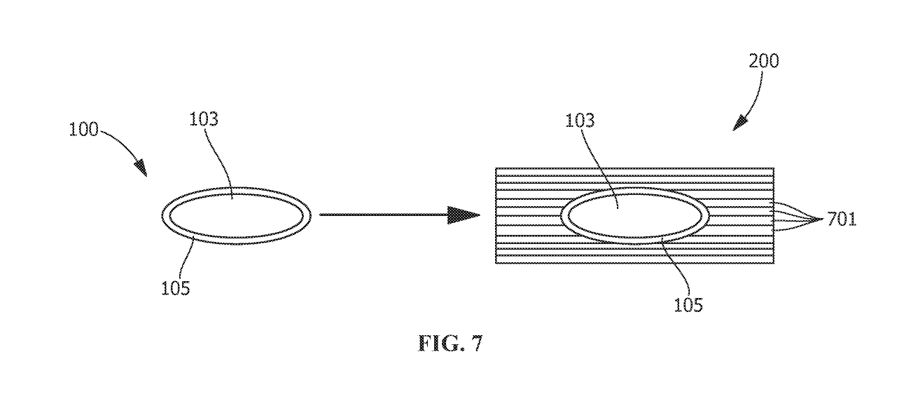

Referring to FIG. 7, in one embodiment, a method of forming the composite component 200 includes providing the composite tool 100, laying-up a plurality of composite plies 701 on a surface of the composite tool 100, and densifying the composite plies 701. In another embodiment, the laying-up of the plurality of composite plies 701 includes positioning the plurality of composite plies 701 in a desired geometry or shape on the composite tool 100. In a further embodiment, the composite plies 701 include, but are not limited to, SiC fibers impregnated with a SiC and carbon matrix with various binders. As illustrated in FIG. 3, providing the composite tool 100 may include forming the composite tool 100, which includes three dimensionally printing the body 103, then applying the coating 503 to the body 103. The applying of the coating 503 includes any suitable application method, such as, but not limited to, spraying, painting, electroplating, dipping, any other deposition method, or a combination thereof.

The densifying of the composite plies 701 includes, but is not limited to melt infiltration, chemical vapor deposition, or other suitable densification methods. For example, in one embodiment, the densifying of the composite plies 701 includes heating the composite plies 701 to a temperature equal to or greater than the glass transition temperature of the three dimensionally printed body. In another embodiment, the glass transition temperature of a three dimensionally printed polymer body includes, for example, a temperature of between about 275° F. and about 450° F., between about 340° F. and about 400° F., equal to or greater than 275° F., equal to or greater than 340° F., equal to or greater than 350° F., equal to or greater than 360° F., equal to or greater than 367° F., equal to or greater than 370° F., or any combination, sub-combination, range, or sub-range thereof. In a further embodiment, the densifying of the composite plies 701 forms the composite component 200 over the composite tool 100, the composite component 200 including a surface geometry corresponding to at least a portion of the composite tool 100. Forming the composite component 200 according to the method disclosed herein decreases a porosity of the composite component 200 and/or increases a fiber strength in the composite component 200.

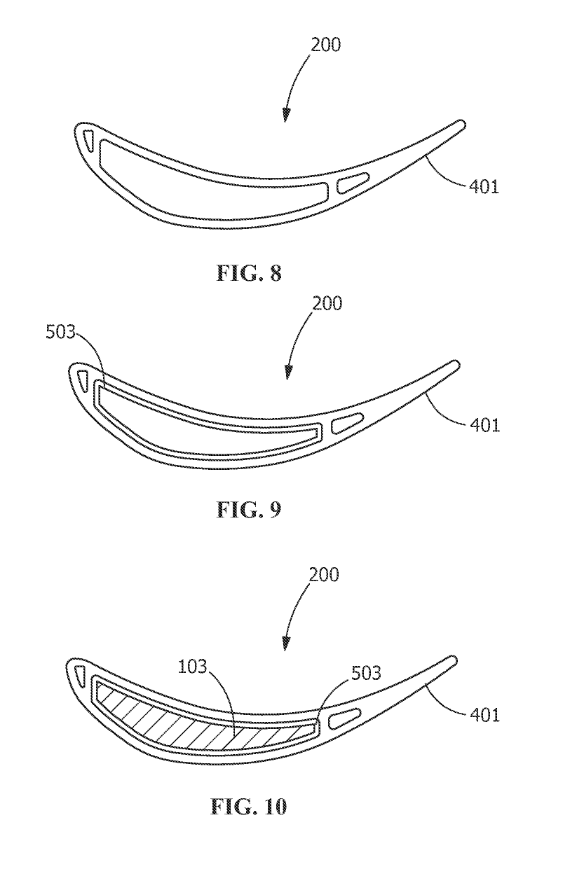

After forming the composite component 200, the method may include removing the composite tool 100 from the composite component 200. For example, in one embodiment, as illustrated in FIG. 8, both the body 103 and the coating 503 of the composite tool 100 are removed from the composite component 200. In another embodiment, as illustrated in FIG. 9, the body 103 is removed from the composite component 200 while the coating 503 remains. Removing the body 103 includes, but is not limited to, melting, leaching, chemically removing, or a combination thereof. The body material may either be removed before or after forming the composite component 200. When the body material is removed before forming the composite component 200, the coating 503 includes a thickness of at least 0.01 inches, at least 0.015 inches, at least 0.02 inches, between about 0.01 and about 0.06 inches, between about 0.01 and about 0.03 inches, or any combination, sub-combination, range, or sub-range thereof. Alternatively, as illustrated in FIG. 10, both the body 103 and the coating 503 remain within the composite component 200.

Additionally, the composite tool 100 may include collapsing features, infill, cross-sectional features, or a combination thereof. The collapsing features, the infill, and/or the cross-section features may be formed before, during, and/or after the three dimensional printing of the body 103 by any suitable formation method. Additionally, the collapsing features, the infill, and/or the cross-section features may include the same or different material as compared to the body 103. For example, the collapsing features, the infill, and/or the cross-section features may be three dimensionally printed with the body 103, or the body 103 may be three dimensionally printed around the collapsing features, the infill, and/or the cross-section features. In one embodiment, the infill includes stiffeners and/or ribs. In another embodiment, the cross-sectional features provide support to the composite tool 100, such as, for example, when the body 103 is removed from within the coating 503.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A composite tool comprising:
a three dimensionally printed polymer body, the body having a geometry corresponding to at least one surface of a gas turbine component; and
a coating overlaying the body, the coating providing the printed polymer body a greater resistance to heat exposure than an uncoated printed polymer body.

2. The composite tool of claim 1, wherein the greater resistance to heat exposure includes survival of exposure to a temperature greater than the glass transition temperature of the three dimensionally printed polymer body.

3. The composite tool of claim 1, wherein the composite tool is a mandrel.

4. The composite tool of claim 1, wherein the three dimensionally printed body includes a plurality of segments.

5. The composite tool of claim 4, wherein the plurality of segments include segments that are attachable to one another to form the geometry corresponding to at least one surface of a gas turbine component.

6. The composite tool of claim 1, wherein the coating comprises a material selected from copper, nickel, and combinations thereof.

7. The composite tool of claim 1, wherein the gas turbine component is one of a turbine blade or shroud.

8. A method of forming a composite tool comprising:
printing a three dimensional polymer body, the body having a geometry corresponding to at least one surface of a gas turbine component; and
applying a coating to the polymer body, the coating providing the printed polymer body a greater resistance to heat exposure than an uncoated printed polymer body.

9. The method of claim 8, wherein the greater resistance to heat exposure includes survival of exposure to a temperature greater than the glass transition temperature of the three dimensionally printed polymer body.

10. The method of claim 8, wherein the greater resistance to heat exposure includes survival of one or more autoclave burnout cycles.

11. The method of claim 8, wherein the three dimensionally printed body includes a plurality of segments.

12. The method of claim 11, wherein the plurality of segments include segments that are attachable to one other to form the geometry corresponding to at least one surface of a gas turbine component.

13. The method of claim 8, wherein the coating comprises a material selected from copper, nickel, and combinations thereof.

14. The method of claim 8, wherein the gas turbine component is one of a turbine blade or shroud.

15. The method of claim 8, wherein the composite tool is a mandrel.

16. A method of forming a composite component comprising:
providing a composite tool comprising:
a three dimensionally printed polymer body; and
a coating overlaying the body, the coating providing the printed polymer body a greater resistance to heat exposure than an uncoated printed polymer body;
laying-up a plurality of composite plies on a surface of the composite tool;
densifying the composite plies to form a composite component; and
removing the composite tool from the composite component;
wherein the composite component includes a surface geometry corresponding to at least a portion of the composite tool.

17. The method of claim 16, wherein the densifying includes heating to a temperature equal to or greater than the glass transition temperature of the three dimensionally printed polymer body.

18. The method of claim 16, wherein the densifying includes heating to a temperature of equal to or greater than 350° F.

19. The method of claim 16, wherein the coating comprises a material selected from copper, nickel, and combinations thereof.

20. The method of claim 16, wherein the gas turbine component is one of a turbine blade or shroud.
